(19) United States
(12) Patent Application Publication
(10) Pub. No.: US 2025/0353238 A1
(43) Pub. Date: Nov. 20, 2025

(54) Method of producing a container from a heated preform

(71) Applicant: SIDEL PARTICIPATIONS, Octeville-sur-Mer (FR)

(72) Inventors: Mikaël DERRIEN, OCTEVILLE-SUR-MER (FR); Mickaël LETESTU, OCTEVILLE-SUR-MER (FR)

(21) Appl. No.: 19/201,214

(22) Filed: May 7, 2025

(30) Foreign Application Priority Data
May 17, 2024 (FR) FR2405081

(51) Int. Cl. B29C 49/64; B29L 31/00

(52) U.S. Cl. CPC B29C 49/6445; B29L 2031/7158

(57) ABSTRACT

Provided is a method of producing a container by deforming a heated preform. The method includes: determining at least two formed zones along the container axis in the body, said formed zones being produced using a different quantity of material, each formed zone corresponding to at least one heated zone of a body of the preform; heating the body of the preform using at least two heating elements that each heat one of the heated zones of the body of the preform; deforming the heated preform to form the container; and before the step of heating the body of the preform, adjusting a heating power of each heating element wherein the heating power of each heating element is adjusted as a function of the quantity of material in the formed zone of the body of the container corresponding to the zone heated by each heating element.

### CROSS-REFERENCE TO RELATED APPLICATIONS

This application claims the benefit of French Application No. FR2405081, filed May 17, 2024, the entire contents of which is hereby incorporated herein by reference.

### BACKGROUND

It is known to heat a preform in a container production installation in order to render the preform pliable and to enable its subsequent deformation by stretch-blow molding for example so as to produce a container from the heated preform. Depending on the shape of the body of the container to be produced, the material of the container in different zones of that body is stretched more or less, which renders the distribution of material in the body of the container non-uniformly, a more stretched zone containing less material than a less stretched zone. The more a zone of the body of the container must be stretched, the higher the heating power must be for the corresponding zone of the body of the preform. In other words, the various zones of the preform must be able to be heated to different temperatures.

To this end the preform is for example circulated in a heat treatment unit, or oven, in which the preform moves in front of the heating elements. The heating elements are in particular distributed in the direction of the height of the body of the preform, that is to say substantially parallel to the axis of the preform along which the body of the preform extends, in order to enable heating to controlled temperatures of a plurality of zones of the body of the preform distributed over the height of the preform. The heating powers of the various heating elements thus make it possible to apply a temperature profile to a preform, that profile depending on the characteristics of the container to be produced from that preform and on the material of the preform.

To ensure correct heating of the preforms it is known to use a regulation loop in which the adjustment of the heating power of the heating elements is controlled according to the temperature of the heated preforms measured in a zone of the preforms following heating of the preforms. The distribution of the heat in the preforms is determined as a function of the measurement of a reference temperature measured in a zone of the preforms and the heating power of the heating elements is adjusted as a function of that reference temperature to approach the temperature profile to be applied to the preforms.

Such a regulation loop does not give entire satisfaction, however. In effect, in particular for zones of the preforms far from the zone in which the reference temperature has been measured, the adjustment of the heating power continues to be based on that reference temperature, which renders the adjustment approximate. One of the objects of the invention is to alleviate these drawbacks.

### SUMMARY

Embodiments of the present disclosure provide for production methods of containers by deformation of a heated preform. The container includes a body extending along a container axis.

An embodiment of the present disclosure includes a method, the method including: determining at least two formed zones along the container axis in the body, said formed zones being produced using a different quantity of material, each formed zone of the body of the container corresponding to at least one heated zone of a body of the preform; heating the body of the preform by means of at least two heating elements, each heating element heating one of the heated zones of the body of the preform, and deforming the heated preform to form the container.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a schematic representation as seen from above of an installation for production of containers enabling use of the production method according to various example embodiments;

FIG. 2 is a schematic representation of an interface for entering a required distribution of material in a container to be produced, enabling use of the production method according to various example embodiments;

FIG. 3 is a schematic representation in section of a preform heated by heating elements; and

FIG. 4 is a schematic representation of another interface for use in a heating step of the production method according to various example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### General Discussion

In accordance with the purpose(s) of the present disclosure, as embodied and broadly described herein, embodiments of the present disclosure, in some aspects, relate to a method for producing a container in which the heating power of the heating elements can be precisely adjusted in order to apply a temperature profile corresponding precisely to the required profile to the preform from which the container is produced during heating thereof.

To this end the disclosure concerns a method of producing a container of the aforementioned type including, before the step of heating the body of the preform, a step of adjustment of a heating power of each heating element in which the heating power of each heating element is adjusted as a function of the quantity of material in the formed zone of the body of the container corresponding to the zone heated by each heating element.

The heating power of each heating element is therefore controlled as a function of the required distribution of the material in different zones of the body of the container to be produced and not as a function of a temperature measured in a zone of a previously heated preform. In other words, the heating power of a heating element is controlled on the basis of the required quantity of material in the zone of the body of the container corresponding to the zone of the body of the preform heated by that heating element, which enables precise adjustment of that heating element. Furthermore, this adjustment can be modified simply by a user if another type of container must be produced or the distribution of material in a container already produced is not satisfactory by entering a new required distribution of material in the container. Furthermore, the heating powers can be adjusted without operating the heat treatment unit beforehand to set up a regulation loop.

The described production method may further have one or more of the following features, separately or in any technically feasible combination: the step of determination of the formed zones of the body includes a step of distribution of the material in the formed zones of said body of the container, wherein a quantity of material to be added in at least one of the formed zones of the body of the container and a quantity of material to be removed in at least one other formed zone of the body of the container are defined, the quantity of material to be added being substantially equal to the quantity of material to be removed; the body of the container includes at least three formed zones, the preform including at least three heated zones corresponding to said formed zones, each heated zone being heated by at least one heating element the heating power of which is adjusted as a function of the quantity of material in the corresponding formed zone; the distribution step includes the definition of a quantity of material to be added in one of the formed zones, a first quantity of material to be removed in another of the formed zones, and a second quantity of material to be removed in a further one of the formed zones, the quantity of material to be added being substantially equal to the sum of the first quantity of material to be removed and the second quantity of material to be removed; when the first quantity of material to be removed is zero, the quantity of material to be added is substantially equal to the second quantity of material to be removed; at least one of the formed zones corresponds to at least two heated zones, the heating powers of the heating elements heating said at least two heated zones being jointly adjusted as a function of the quantity of material defined for said corresponding formed zone; the at least two heated zones corresponding to a formed zone are adjacent heated zones along a preform axis corresponding to the container axis; each heating element includes a plurality of sources of monochromatic or pseudo-monochromatic electromagnetic radiation.

The method can include a step of producing a container blank, the quantity of material in each formed zone being defined as a function of a measured thickness of a wall of the body of said container blank or visual observation of said body, where each heated zone of the body of the preform extends over a height measured along the container axis between 4 mm and 5 mm.

Turning now to the drawings, exemplary embodiments are described in detail.

### Examples

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

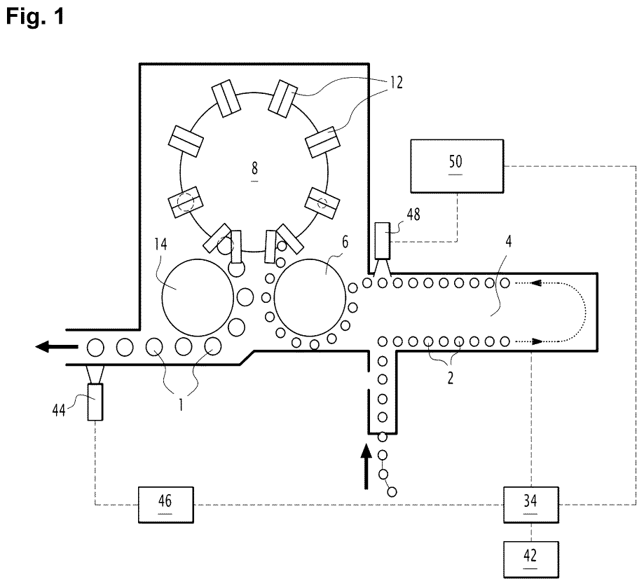

There is described with reference to FIG. 1 an installation for production of containers 1 from a succession of preforms 2. In known manner and in the order in which the preforms 2 and the containers 1 circulate in the installation, such an installation includes a heat treatment unit 4, or oven, a transfer wheel 6 and a forming station 8.

The heat treatment unit 4 is adapted to heat a succession of preforms 2 transported in the heat treatment unit 4 by a system for holding and moving the preforms 2 so as to cause them to move in front of heating elements 10 as described in more detail below.

The transfer wheel 6 is adapted to recover the heated preforms 2 at the outlet of the heat treatment unit 4 and to transfer them into the forming station 8.

The forming station 8 is for example a carousel carrying a plurality of molds 12 forming molding cavities having the shape of the containers 1 to be produced. Each heated preform 2 is placed in a mold and deformed so as to acquire the shape of a container 1 by stretch-blow molding for example. The containers 1 formed are recovered on leaving the forming station, for example by means of another transfer wheel 14, for example to be routed to other stations of the installation, such as a labelling station, a filling station and a station for fitting a cap to the containers.

As indicated above, such an installation is known in itself and is not described in more detail here. It is nevertheless to be understood that the arrangement of the installation represented in FIG. 1 is provided by way of example only and that the invention applies to any type of installation arrangement including a heat treatment unit 4.

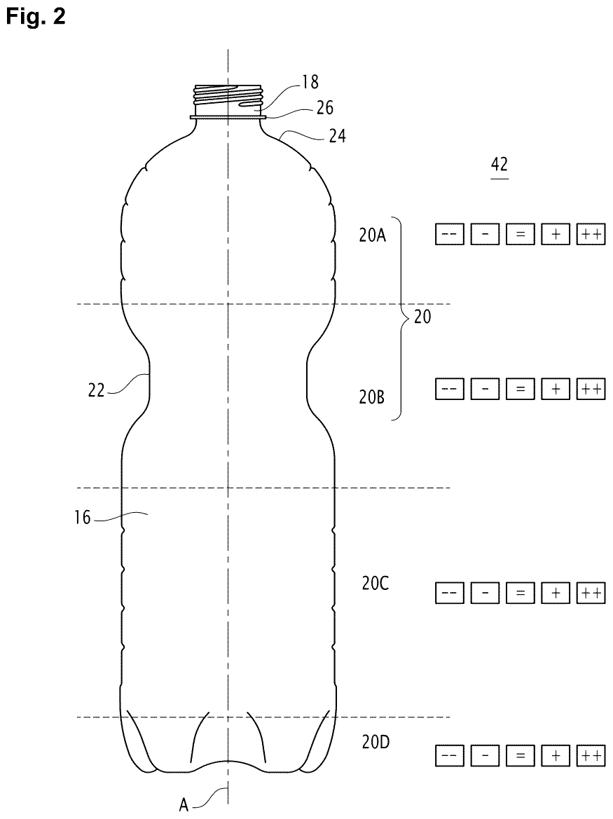

As represented in FIG. 2, each container 1 produced by such an installation includes a body 16 and a neck 18. The body 16 extends along a container axis A and can have any required shape, the shape of the body 16 represented in FIG. 2 being shown by way of example only. To be more specific, the shape of the body 16 can be defined by a plurality of zones, referred to as formed zones 20, a given formed zone 20 having for example a different shape to the formed zone or zones 20 adjacent to this given formed zone 20 along the container axis A. The body 16 generally includes at least two formed zones 20 along the container axis A produced from different quantities of material. In other words, each formed zone 20 contains a different quantity of material to the other formed zone 20. This distribution of material is for example due to the fact that the formed zones 20 have different shapes and necessitate different stretching of the material, as described below. The number of formed zones 20 can vary according to the container 1 to be produced.

In the FIG. 2 example, the container therefore includes for example an upper formed zone 20A, a central formed zone 20B, a lower formed zone 20C and a bottom formed zone 20D. The central formed zone 20B forms a recess or constriction 22 relative to the upper formed zone 20A and the lower formed zone 20C. The upper formed zone forms a shoulder 24 in which the diameter of the container decreases as far as the neck 18. Various ribs or grooves can be provided in one or more formed zones 20; the shape and the number of such ribs or grooves can be different according to the formed zone 20 in which they extend. As indicated above, because of these different shapes of the formed zones 20 the quantity of material in each formed zone 20 can be different from the quantity of material in one or more other formed zones 20.

By “quantity of material” is meant a given mass of material, notably of PET, in a given zone of the container obtained by blow molding or stretch-blow molding, that is to say a mass per unit surface area expressed in grams per square centimeter.

For example, the quantity of material in the bottom of a container, expressed as the mass per unit surface area in grams per square centimeter, means that at different places in the bottom of the formed container it has different thicknesses. It is then difficult for the operator to rely on the thickness for the design or production of a container. This will depend on the quantity of material that must be used in the bottom, that is to say the mass that may be added to or removed from the bottom of the container to have a stronger container, for example adding or removing 0.5 gram from the bottom.

In effect, blow molding or stretch-blow molding a preform to obtain a finished container does not enable a constant thickness to be obtained over all of a formed zone of the container. The thickness of the wall of the container in a formed zone varies in accordance with a plurality of parameters such as the physical and chemical characteristics of the material and parameters of the forming method, whereas the thickness of the wall of a preform is substantially constant and controlled. This is explained by the method of producing the preform, that is to say injection molding or compression injection molding.

The neck 18 includes for example a flange 26 extending from a radial plane substantially perpendicular to the container axis A and projecting toward the exterior of the body 16. Such a flange 26 forms for example a surface for holding the preform 2 and the container 1 produced from the preform 2. The part of the container 1 extending from the flange 26 as far as the open end includes for example a thread enabling a cap to be fixed onto the container 1. It should be noted that the neck 18 is not deformed during the production of the container 1, that is to say that the neck 18 has the same shape in the preform 2 and in the container 1 produced from that preform 2. Consequently, the neck is designated by the same reference number in the preform 2 and in the container 1.

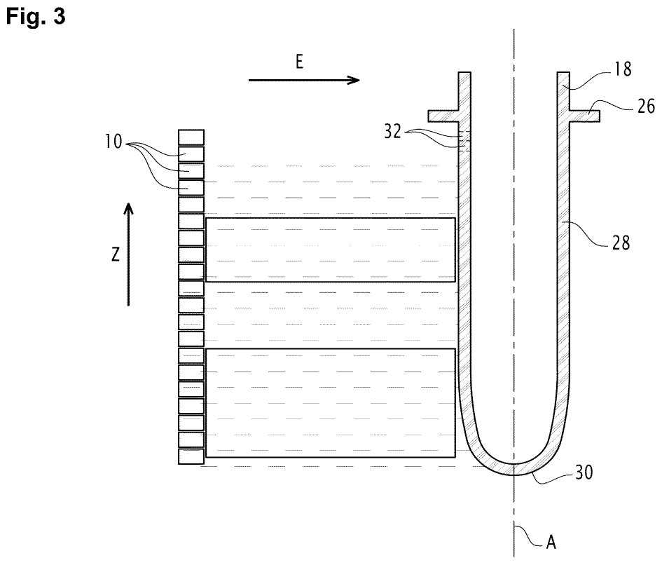

As described above, the container 1 is obtained by deforming and stretching a preform 2 heated in the heat treatment unit 4. Such a preform is represented in FIG. 3 and comprises a body 28 and a neck 18 and the heat treatment unit 4 is adapted to heat the body 28 without heating the neck 18 of each preform 2, as described in more detail below. The body 28 extends along a preform axis corresponding to the container axis A and designated by the same reference in FIG. 3 and has for example the shape of a test tube extending between a bottom 30 and the neck 18, which forms an open end of the test tube.

The heat treatment unit 4 is adapted to heat the body 28 of each preform 2 in order to increase the temperature of the body 28 above the glass transition temperature of the material forming the body 28 so that the body 28 acquires a pliable character enabling its deformation to form a container 1.

To this end and as represented in FIG. 3 the preforms 2 circulate in front of at least two heating elements 10 adapted to radiate heat toward the body of the preforms 2 passing in front of them. To be more specific, the heating elements 10 are disposed one above the other in an elevation direction Z of the heat treatment unit 4 substantially parallel to the preform axis A when a preform 2 is placed in the heat treatment unit 4. Thus the heating elements 10 are disposed so as to expose the whole of the body 28 of the preform 2 to the radiation, to be more specific from the bottom 30 to the neck 26 of the preform 2. Each heating element 10 is more particularly adapted to heat a zone, referred to as a heated zone 32, of the body 28 of a preform 2, the heated zone 32 extending over a part of the height of the body of the preform 2 measured along the preform axis A. In other words, the body 28 of each preform 2 includes at least two heated zones 32 disposed one above the other along the preform axis A, each heated zone 32 extending in front of a corresponding heating element 10 so as to be exposed to the heat emitted by that corresponding heating element 10 when the preform 2 circulates in the heat treatment unit 4. Alternatively, the heat treatment unit 4 includes at least one heating cavity adapted to heat each preform 2 individually. In other words, the preforms 2 do not then circulate in the heat treatment unit 4. Such a heat treatment method is known as “cavity heating”.

Each heating element 10 includes for example a plurality of monochromatic or pseudo-monochromatic sources of electromagnetic radiation. To be more specific, each heating element 10 is for example a laser emitter and the sources of radiation are laser chips adapted to emit laser radiation in the infrared range in an emission direction E substantially perpendicular to the elevation direction Z and corresponding to the direction separating the heating elements 10 from the body 28 of the preforms 2 circulating in the heat treatment unit 4. The sources of radiation are for example arranged alongside one another on a support so as to form at least one row of radiation sources extending in the longitudinal direction. In one embodiment, the radiation sources form at least one upper row and at least one lower row disposed one above the other in the elevation direction.

Such heating elements are described for example in the document FR 3 124 030 and the person skilled in the art can refer to that document to obtain more details, notably concerning the structure of each source oof radiation, the arrangement of the sources of radiation on a support, the interconnection of the sources of radiation and the cooling of the heating elements. It is understood that the invention is not limited to heating elements formed by laser emitters and applies equally to other types of heating element, such as tubular incandescent lamps of halogen or microwave type.

It should nevertheless be noted that the invention is particularly suited to laser emitters because such laser emitters emit radiation with very little dispersion, that is to say oriented mainly in the emission direction E, unlike halogen heating elements that generate a particularly wide radiation emission cone. Laser emitters therefore enable heating of a very localized heated zone 32 of the body 28 of the preform 2 whereas a halogen heating element would heat a more extensive zone and the radiation emitted by that heating element and/or the reflection of that radiation in the heat treatment unit 4 would risk interfering with the radiation emitted by another heating element and thus heating a heated zone other than that for which it is designed, which reduces the effectiveness of the adjustment of the heat treatment unit 4 described below.

Using such laser emitters each heated zone 32 has for example a height between substantially 4 mm and 5 mm, for example substantially equal to 4.7 mm. In one embodiment a preform 2 includes between eighteen and thirty-six heated zones 32, the heat treatment unit 4 including at least as many heating elements 10 arranged in a column extending in the elevation direction Z, each heating element 10 in the column being adapted to heat one of the corresponding zones 32 depending on the height of the body 28 of the preforms 2.

In one embodiment the heat treatment unit includes a plurality of columns of heating elements 10 disposed alongside one another in the direction of circulation of the preforms 2 in the heat treatment unit 4 so that the preforms pass in front of a succession of heating elements 10 when they circulate in the heat treatment unit 4. In other words, a heated zone 32 of the body 28 of a preform 2 is heated by a plurality of heating elements 10 extending to the same height in the elevation direction Z when the preform 2 circulates in the heat treatment unit 4. In one embodiment the preform 2 is further driven in rotation on itself about its preform axis A when it circulates in the heat treatment unit 4 so that the whole circumference of the body 16 is exposed to the radiation from the heating elements 10. Each heated zone 32 therefore extends over all of the circumference of a portion of the body 28 of each preform 2. However, as described below, in the case of asymmetric deformation of the body 28 of the preform 2 in a heated zone 32 the temperature of that heated zone 32 is not uniform over the whole circumference of the preform

The heating power of each heating element 10 can be adjusted by means of a control device 34 of the heat treatment unit 4. The control device 34 thus enables adjustment of the heating of each heated zone of the preform 2 in order to manage the temperature profile that is applied to it. In effect, in known manner, the heated zones 32 of the same preform 2 are not necessarily heated to a uniform temperature. The temperature of a heated zone 32 depends in particular on the shape of the container 1 to be produced from the preform 2. To be more specific, as described above, the more a given zone of a preform 2 has to be deformed, or stretched, to form the container 1, the higher the temperature to which it has to be heated. Referring to the example of a shape of the container 1 represented in FIG. 2, the zones of the body 16 extending in the vicinity of the neck 18, forming the shoulder 24 in the upper formed zone 20A and the zones of the body of the lower formed zone 20C of the body 16 extending in the vicinity of the bottom, could therefore be heated to a higher temperature than that necessary for the zones at the level of the constriction 22 extending substantially at the mid-height of the container 1 in the central formed zone 20B.

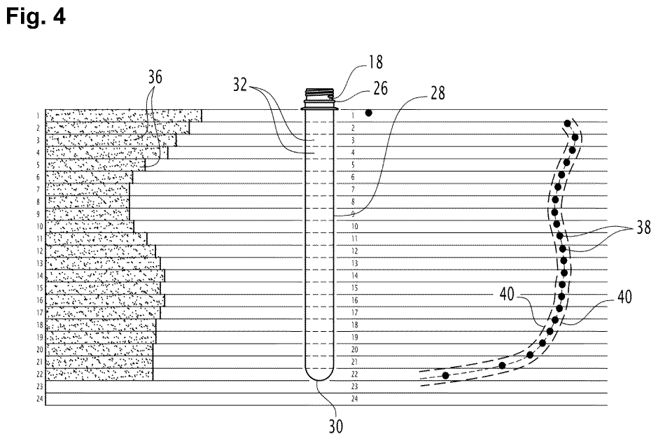

Each formed zone 20 of a container 1 therefore corresponds to at least one heated zone 32 of a corresponding preform 2. A formed zone 20 generally corresponds rather to at least two or more adjacent heated zones 32 along the preform axis A. Returning to the example of the shape of a container 1 represented in FIG. 2, the central formed zone 20B therefore corresponds to the heated zones 32 heated by the heating elements 10 numbered 6 to 10 in FIG. 4.

As represented in FIG. 4, the control device 34 therefore enables adjustment of the heating power of a particular heating element 10, as represented by the histogram on the left in FIG. 4, as a function of the temperature to which the heated zone 24 corresponding to this particular heating element 10 must be heated, as represented by the right-hand graphic in FIG. 4. In this figure showing an example of a display of the adjustment applied by the control device 34 to the heating elements there are twenty-four heating elements 10 numbered 1 to 24 and bars 36 of the histogram each represent the heating power of one of these heating elements 10 as a function of the heated zone 32 of the preform 2 facing these heating elements 10. In FIG. 4 the body of the preform 2 comprises twenty-two heated zones 32. In the right-hand graphic each point 38 represents the required temperature, referred to as the target heating temperature, for the corresponding heated zone 32. Looking at this figure, it is therefore seen that the higher the target heating temperature of a heated zone 32 the higher the heating power of the corresponding heating element 10 must be. In the FIG. 4 example it is seen for example that the heating power of the heating elements 6 to 10 is significantly lower than the heating power of the other heating elements, which makes it possible to produce the constriction 22 of the container 1 represented in FIG. 2.

The heating power 10 is adjusted so that each heated zone 32 is heated to a temperature substantially equal to the corresponding target heating temperature as a function of the quantity of material required in a formed zone 20 corresponding to a heated zone 32, as described in more detail below. It should therefore be noted that by “substantially equal” is meant that the target heating temperature is situated or not in an acceptable range around the target heating temperature, as represented by the two dashed line curves 40 represented around points 38 in the right-hand graphic in FIG. 4. In other words, the target heating temperature is situated between an acceptable low heating temperature lower than the target heating temperature and an acceptable high heating temperature higher than the target heating temperature. In one embodiment, the acceptable heating temperatures correspond to the target heating temperature to within plus or minus 2%. It should be noted that the two acceptable heating temperature curves 40 are not necessarily symmetrical to one another relative to the target heating temperature. In other words the difference between the low acceptable heating temperature and the target heating temperature and the difference between the target heating temperature and the high acceptable heating temperature for each point can be different.

When the heat treatment unit 4 includes a plurality of columns of heating elements 10 the heating power of the heating elements 10 of the same row, that is to say the heating elements 10 extending heightwise in the elevation direction Z, is constant. When the control device 34 controls the heating power of a particular heating element 10, that heating power is therefore applied to all the heating elements 10 situated at the same height as that particular heating element. However, if the container 1 to be formed features at least one formed zone 20 in which the section is not circular, the heating power of the heating elements 10 situated at the height of that formed zone 20 can be modulated to enable asymmetric deformation of the preform 2 in that zone.

The production method according to the invention has a preform move in the heat treatment unit 4 facing the heating elements 10 during a heating step, the heating power of each heating element 10 being adjusted by the control device 34 as a function of the quantity of material in each formed zone 20 of the container 1 to be produced during a step of adjusting the heating power of each heating element 10 as indicated above. To this end the control device 34 of the heat treatment unit 4 includes for example a human-machine interface 42 for entering a required distribution of the material in a container to be produced represented in FIG. 2. Via this interface an operator can act on the required quantity of material in a particular formed zone 20, for example by means of the icons−−, −, =, + and ++represented in FIG. 2. The icon−− is used to indicate that the quantity of material in the corresponding formed zone 20 must be greatly reduced, the icon−a lower reduction of the quantity of material, the icon=an unchanged quantity of material, the icon +an increased quantity of material and the icon++a greater increase in the quantity of material. It is understood that these icons are specified by way of example only and that other types of icons or inputs could be used to indicate the required quantity of material in a formed zone 20, such as digits or numbers.

The control device 34 is configured to modify the heating power of the heating element or elements 10 of the heating zone or zones 32 corresponding to each formed zone 20 of the container as a function of information entered by the operator. Returning to the interface example 42 represented in FIG. 2, if the operator has interacted with the icon+for a given zone 20, the control device 34 is therefore configured to reduce the heating power of the heating element 10 heating the heated zone or zones 32 corresponding to this given formed zone 20. If the operator has interacted with the icon−for a given formed zone 20, the control device 34 is configured to increase the heating power of the heating element or elements 10 heating the heated zone or zones 32 corresponding to that given formed zone 20. If the icons++ or −−are actuated the heating power is reduced or increased more. If the icon=is actuated the heating power 10 remains unchanged.

During initial setting up of the heat treatment unit 4 the container 1 presented at the interface 42 is for example a container obtained when the distribution of the material is uniform throughout the body 16 of the container 1. Depending on the required container shape, the operator actuates the icons to modify this distribution of material in the various formed zones 20 during a step of distribution of the material in the formed zones 20 of the body 16 of the container 1 during a step of determination of the formed zones 20 of the body 16. The control device 34 modifies the heating power of the heating elements 10 accordingly.

To produce the central formed zone 20B including a constriction 22 for example, the operator therefore interacts with the icon+ or ++ to indicate that the required quantity of material in that central formed zone 20B is greater and the control device 34 reduces the heating power of the heating elements 10 heating the corresponding heated zones 32 of the central formed zone 20B, for example the heating elements 10 numbered 7 to 9 in FIG. 4. If a transition has to be made between the constriction 22 and the adjacent formed zones 20, the control device 34 also adapts the heating power of the heating elements 10 numbered 6 and 10 so that they are between the heating power of the heating elements 10 numbered 7 to 9 and the heating power of the heating element 10 numbered 5 and the heating element 10 numbered 11, as can be seen in FIG. 4.

Likewise, to produce an upper formed zone 20A including a shoulder 24 the operator interacts with the icon− or −− to indicate a smaller quantity of material in that formed zone 20B and the control device 34 increases the heating power of the heating element 10 numbered 1 in FIG. 4 and adapts the power of the heating elements 10 numbered 2 to 5 so as to be able to produce the transition to the central formed zone 20B.

When the operator has modified the quantity of material in a given formed zone 20 they are prompted by the interface 42 to modify the quantity of material in one or more other formed zones 20 accordingly. In effect, for a given total quantity of material for a container, if the quantity of material in a formed zone 20 is increased, the quantity of material in at least one other formed zone 20 must be reduced correspondingly. In other words, the step of determination of the formed zones 20 includes a step of distribution of the material in the formed zones 20 of the body 16 of the container 1 in which a quantity of material to be added in at least one of the formed zones 20 of the body 16 of the container 1 and a quantity of material to be removed in at least one other formed zone 20 of the bodies 16 of the container 1 are defined, the quantity of material to be added being substantially equal to the quantity of material to be removed. By “substantially equal” is meant that these quantities of material are equal to within plus or minus 5%. If the container 1 includes at least three formed zones 20 the distribution step includes the definition of a quantity of material to be added in one of the formed zones 20, a first quantity of material to be removed in another of the formed zones 20 and a second quantity of material to be removed in a further one of the formed zones 20, the quantity of material to be added being substantially equal to the sum of the first and second quantities of material to be removed. If the quantity of material cannot be modified in one of the formed zones, that is to say if the first quantity of material to be removed is zero for example, then the quantity of material to be added is substantially equal to the second quantity of material to be removed. Returning to the interface 42 represented in FIG. 2, in concrete terms this means that if the operator interacts with the icon+ in a formed zone 20 they are prompted to interact with the icon− in another formed zone 20 of their choice. If the operator interacts with the icon++ in a formed zone 20 they are prompted to interact with the icon−− in another formed zone 20 or with the icon− in two other formed zones 20.

In an embodiment that is an alternative to or complements the embodiment described hereinabove, the control device 34 is configured to modify automatically the quantity of material in a formed zone 20 to take account of modification by the operator of the quantity of material in another formed zone 20. For example, if the operator interacts with the icon+ in a first formed zone 20 and with the icon= in a second formed zone 20, the control device 34 therefore automatically reduces the quantity of material in a third formed zone 20 when the container comprises three formed zones 20.

In one embodiment the method produces at least one container 1 blank with the initial adjustment carried out by the operator and the operator and/or the control device 34 can modify the adjustment by means of the interface 42 after examining the container produced in order to modify the distribution of material accordingly if the shape of the container obtained does not conform to the required container shape. This observation can for example be carried out by measuring the thickness of the wall of the container 1 blank obtained in the various formed zones 20 and comparing the measured thicknesses with the required thicknesses. Depending on this comparison, the operator and/or the control device 34 can modify the adjustment of the heat treatment unit 4 to adapt the heating power of the heating elements 10 accordingly. Thus if the thickness measured in a given formed zone 20 is less than the required thickness in that formed zone 20 this signifies that there is insufficient material in this formed zone 20. The operator can then modify the distribution of the quantity of material in the container to increase the required quantity of material in that given formed zone 20. Alternatively or additionally to this the control device 34 can directly modify the heating power of the heating elements 10 corresponding to that given formed zone 20 to increase the quantity of material in that given formed zone 20. To this end, the installation for production of containers 1 includes for example a thickness measuring device 44 situated at the exit of the forming station 8 or downstream of the other transfer wheel 14, as represented in FIG. 1. The thicknesses are acquired by a processor device 46 of the thickness measuring device 44 and are transmitted to the control device 34 to supply the information to the control device 34 and/or the operator.

The observation of the container can alternatively or additionally be a visual observation in order to detect defects in the body 16 thereof such as traces of burns, overstretching and/or crystalization. In effect, if a heated zone 32 of the body of the preform 2 is heated to a temprature higher than the target temperature such defects can appear in the corresponding formed zone 20 of the body 16 of the container 1 and be visible only once the container has been produced. It is then necessary to modify the adjustment of the heating power of the corresponding heating element 10 to prevent the appearance of such defects. To this end, the installation for production of containers 1 includes for example a device for acquisition of images of the container 1 obtained at the exit of the forming station 8 instead of or in addition to the thickness measuring device 44. In one embodiment the thickness measuring device 44 and the image acquisition device are formed by the same acquisition means, such as a thermal imaging video camera. It is equally understood that visual observation of the container can be done by the naked eye by an operator who modifies the adjustment of the heat treatment unit 4 if they observe the appearance of defects in the body 16 of the container 1.

Additionally, a regulation loop can be used to modify the heating power of the heating elements 10 as a function of one or more temperatures measured in one or more heating zones 32 of the preforms 2 after the latter have circulated in the heat treatment unit 4. The heating power of the heating element is then modified by the control device 34 if a difference is found between the measured temperature or temperatures and the target temperature or temperatures of the heated zones 32. To this end the production installation includes for example a device 48 for measuring the temperature in at least one heated zone 32 in the vicinity of the exit of the heat treatment unit 4. The measuring device 48 is preferably adapted to measure the temperature of each heated zone 32 of a preform 2 that has been heated by the corresponding heating elements 10 of the heat treatment unit 4. Such a measuring device 48 is formed for example by a thermal imaging video camera arranged at the exit of the heat treatment unit and acquiring an image, for example an infrared image, of each heated preform 2 transferred to the transfer wheel 6, as represented in FIG. 1. Alternatively, the measuring device 48 includes one or more pyrometers each adapted to measure the temperature of a heated zone 32 of the body 28 of at least one preform 2. The temperatures are acquired by a processor device 50 of the measuring device 48 and are transmitted to the control device 34.

The control device 34, the interface 42 and where applicable the processor device 46 of the thickness measuring device 44 (and/or of the image acquisition device) and the processor device 50 of the temperature measuring device 48 are able to implement a production method as described hereinabove.

These devices are electronic circuits designed to manipulate and/or to transform data represented by electronic or physical quantities in registers of the devices and/or memories into other and similar data corresponding to physical data in the memories of registers or other types of display, transmission or storage device.

By way of specific examples, the control device 26 and the processor devices 36, 44 are programmable logic components, such as field-programmable gate arrays (FPGA) or integrated circuits such as application-specific integrated circuits (ASIC).

Alternatively, if the method is implemented in software, that is to say in the form of a computer program, also referred to as a computer program product, it is further adapted to be stored on a computer-readable medium that is not represented. The computer-readable medium is for example a medium adapted to store electronic instructions and to be coupled to a bus of a data processing system. The readable medium is for example an optical disc, a magneto-optical disc, a ROM, a RAM, any type of non-volatile memory (for example FLASH or NVRAM memory) or a magnetic card. The readable medium then stores a computer program comprising software instructions.

The production method according to the invention enables simple and intuitive adjustment of the heating power of the heating elements 10 as a function of the shape of the container 1 to be produced. The operator does not need to act directly on the heating power to establish the required target temperature profile or to establish for themselves this target temperature profile to adjust the heat treatment unit 4. In effect, the link between the target temperature profile and the shape of the container obtained with such a profile is complex and generally necessitates working by trial and error to obtain the required container when the heat treatment unit 4 is adjusted by entering the target temperature profile, which necessitates the heat treatment unit 4 functioning for a certain time period before the required result is obtained. Using the method according to the invention the adjustment can be made without the heat treatment unit 4 functioning and a definitive adjustment can be obtained by possibly causing the production installation 1 to function for a short time period to obtain a container blank and to refine the adjustment accordingly.

Therefore, at least the following is claimed:

1. A method of production of a container by deformation of a heated preform, the container including a body extending along a container axis, said method comprising the following steps:
determining at least two formed zones along the container axis in the body, said formed zones being produced using a different quantity of material, each formed zone of the body of the container corresponding to at least one heated zone of a body of the preform;
heating the body of the preform using at least two heating elements, each heating element heating one of the heated zones of the body of the preform;
deforming the heated preform to form the container; and
wherein the method further comprises, before the step of heating the body of the preform, adjusting a heating power of each heating element wherein the heating power of each heating element is adjusted as a function of a quantity of material in the formed zone of the body of the container corresponding to the heated zone heated by each heating element.

2. The method as claimed in claim 1, wherein the step of determining the formed zones of the body further comprises:
a step of distribution of the material in the formed zones of said body of the container, wherein a quantity of material to be added in at least one of the formed zones of the body of the container and a quantity of material to be removed in at least one other formed zone of the body of the container are defined, wherein the quantity of material to be added is substantially equal to the quantity of material to be removed.

3. The method as claimed in claim 1, wherein the body of the container includes at least three formed zones, the preform including at least three heated zones corresponding to said formed zones, each heated zone being heated by at least one heating element the heating power, wherein the heating power is adjusted as a function of the quantity of material in the corresponding formed zone.

4. The method as claimed in claim 2, wherein the distribution step comprises defining: a quantity of material to be added in one of the formed zones, a first quantity of material to be removed in another of the formed zones, and a second quantity of material to be removed in a further one of the formed zones, the quantity of material to be added being substantially equal to a sum of the first quantity of material to be removed and the second quantity of material to be removed.

5. The method as claimed in claim 4, wherein when the first quantity of material to be removed is zero, the quantity of material to be added is substantially equal to the second quantity of material to be removed.

6. The method as claimed in claim 3, wherein at least one of the formed zones corresponds to at least two heated zones, the heating powers of the heating elements heating the at least two heated zones, the heating powers being jointly adjusted as a function of a quantity of material defined for said corresponding formed zone.

7. The method as claimed in claim 6, wherein the at least two heated zones corresponding to a formed zone are adjacent heated zones along a preform axis corresponding to the container axis.

8. The method as claimed in claim 1, wherein each heating element comprises a plurality of sources of monochromatic or pseudo-monochromatic electromagnetic radiation.

9. The method as claimed in claim 1, further comprising a step of producing a container blank, the quantity of material in each formed zone being defined as a function of a measured thickness of a wall of the body of the container blank or a visual observation of said body.

10. The method as claimed in claim 1, wherein each heated zone of the body of the preform extends over a height measured along the container axis between 4 mm and 5 mm.
